(19) United States
(12) Patent Application Publication
(10) Pub. No.: US 2015/0101289 A1
(43) Pub. Date: Apr. 16, 2015

(54) LOOSE FILL FIRE-PROTECTIVE PACKING MEDIA

(71) Applicant: AkroFire, Inc., Lenexa, KS (US)

(72) Inventors: Timothy Johnson, Bartlesville, OK (US); Jonathan Green, Shawnee, KS (US); John V. Robertson, Kansas City, MO (US); Geren G. Houser, Edgerton, KS (US)

(73) Assignee: AKROFIRE, INC., Lenexa, KS (US)

(21) Appl. No.: 14/511,727

(22) Filed: Oct. 10, 2014

Related U.S. Application Data
(60) Provisional application No. 61/889,952, filed on Oct. 11, 2013.

(51) Int. Cl. B65D 81/38; B29C 44/56; B29C 44/02; B65B 55/20

(52) U.S. Cl. CPC B65D 81/38; B65B 55/20; B29C 44/5681; B29C 44/02; B29L 2009/005
USPC 53/474; 428/376; 264/45.1

(57) ABSTRACT

A loose fill packing media that can be used to protect packed items from heat and flame or to contain combustion and heat generated by a packed item comprises a plurality of foam cores formed from a cured thermoset resin coated with a layer of an intumescent material. The foam may be formed by mixing a thermoset resin with micro-balloons and a heat absorbing phase change material, adding a catalyst and shaping the mixture into pellets, curing the shaped pellets and then coating the pellets with the intumescent material. The pellets flow freely at room temperature to facilitate pouring into a box around a package to be protected. If the temperature becomes sufficiently elevated, the intumescent material foams and then chars holding the pellets together. The layer of pellets significantly impedes heat transfer to or from the package surrounded by the pellets.

### CROSS REFERENCE TO RELATED APPLICATION

This application claims the benefit of the prior filed, co-pending provisional application, Ser. No. 61/889,952, filed Oct. 11, 2013.

### BACKGROUND OF THE INVENTION

This invention relates generally to packing media and more particularly to flame and heat-resistant, insulative and heat-absorbing packing media or material that can be used to protect packed items from heat and flame or to contain combustion and heat generated by a packed item. Embodiments include a loose-fill packing media for preventing or containing lithium battery heat release. The beneficial features of the packing extend to other packed items that may be heat-sensitive and potentially hazardous, such as pressurized gases such as oxygen, or chemical oxygen generators.

Lithium batteries contain a high level of energy per unit weight and volume and typically have a higher energy density than other types of batteries in use. Types of lithium batteries include lithium ion and polymer lithium batteries, which are typically rechargeable, and lithium metal batteries, which are typically not rechargeable. Lithium batteries typically contain volatile components that are combustible or flammable, particularly when in a vapor state or expelled from the battery housing as a mist.

Due to the energy density of lithium batteries, they are particularly susceptible to becoming chemically unstable upon overheating and may undergo a condition known as thermal runaway. Thermal runaway, initiated by mechanical abuse, by exposure to temperatures over 300° F. (149° C.), or by defects, is a chain reaction in which rising battery temperature accelerates chemical reactions in the battery. The chemical reactions also give off heat, which, if not absorbed or allowed to escape, further accelerates the reactions, initiating runaway in neighboring batteries. This situation is particularly dangerous in close, confined spaces, such as the cargo hold of an aircraft. Lithium battery runaway has been identified in a number of incidents, causing damage and lost time. Federal regulations have been implemented that restrict lithium battery transport via aircraft.

What is needed, therefore, is a means for protecting packaged lithium batteries from elevated temperatures sufficient to cause thermal runaway, or to contain heat and flame generated by lithium batteries should thermal runaway occur within a package.

### SUMMARY OF THE INVENTION

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter.

A purpose of this invention is to provide a flame- and heat-resistant, insulative, loose fill packing media that can be used to protect packed items from heat and flame or to contain combustion and heat generated by a packed item. Certain embodiments include a loose-fill packing media that, upon excess heating, softens or becomes semi-fluid and sticky or tacky, then foams, and then chars and solidifies to encapsulate, insulate and protect packaged materials. Certain embodiments include such a packing media optimized to (a) insulate lithium batteries from externally applied excessive heat which might otherwise initiate thermal runaway and/or to (b) encapsulate and contain heat and flame generated by lithium batteries in a thermal runaway condition. The packing material exhibits fire resistance, including resistance to direct flame impingement. It also exhibits heat absorption, thermal insulation and thermal stability.

An embodiment of the loose fill packing media comprises a foam core formed from a thermoset resin and a coating of a material applied over the foam core which becomes sticky or tacky at a first elevated temperature and foams at a second elevated temperature. The coating also preferably chars at or above the second elevated temperature. The coating may comprise an intumescent material.

In one embodiment the foam core comprises micro-balloons dispersed in a matrix of the thermoset resin. The foam core may further comprise fine particles of a phase change material dispersed therein which absorb heat as the material changes phase in response to rising temperature. The phase change material may comprise a hydrous inorganic material. The foam core may also include a filler such as expanded polystyrene beads dispersed therein to reduce the amount and cost of micro-balloons and thermoset resin used and to further reduce the weight of the packing media.

The loose fill packing media may be formed by mixing micro-balloons with a thermoset resin to form a foam premix, adding a catalyst to the foam premix to induce curing of the thermoset resin around the micro-balloons, then shaping the catalyzed foam premix into uncured foam cores, curing the foam cares and then coating the cured foam cores with an intumescent material. In an alternative process, micro-balloon precursors are mixed with the thermoset resin which is then heated to a temperature at which a volatile compound within the precursors volatilizes, expanding the micro-balloon precursors to form micro-balloons and thereby forming the foam premix to which the catalyst is then added.

The resulting loose fill packing media can then be used with boxes, including conventional cardboard boxes, hazmat boxes in particular, to surround combustible materials, such as lithium batteries, within the box to protect the packed items from heat and flame and to contain any heat or flames generated by combustion of the packed items.

Other advantages of the invention will become apparent from the following description taken in connection with the accompanying drawings, wherein is set forth by way of illustration and example an embodiment of the present invention.

### BRIEF DESCRIPTION OF THE DRAWINGS

FIG. 1 is a perspective view of a loose fill packing pellet.

FIG. 2 is a cross-sectional view of the packing pellet taken along line 2-2 of FIG. 1 showing a coating over a foam core with relative dimensions not drawn to scale.

FIG. 3 is a fragmentary, diagrammatic view of a greatly enlarged cross-sectional view of the pellet of FIG. 2 showing expanded microspheres and fine particles of heat absorbing material dispersed within a cured thermoset resin matrix and coated with the coating.

FIG. 4 is a cross-sectional view similar to FIG. 2 showing an alternative embodiment of the foam core having polystyrene beads dispersed in the foam core.

FIG. 5 is a top plan view of an alternatively shaped foam core formed using expandable microspheres.

FIG. 6 is a cross-sectional view of the alternatively shaped foam care taken along line 6-6 of FIG. 5.

FIG. 7 is a photograph of a package of 100 CR123A-type batteries and a single 75-watt cartridge heater to be subjected to a thermal runaway test while packed in a protective packing media comprising pellets shown in FIGS. 1 and 2.

FIG. 8 is a photograph showing a portion of packing material inside a lower portion of a Hazmat cardboard box or carton with the battery pack placed on top of the packing material.

FIG. 9 is a photograph showing the carton of FIG. 7 with additional packing pellets added to cover the battery pack and substantially fill the carton.

FIG. 10 is a photograph of the remains of the packing material following a thermal runaway test after the outer box has been cut and removed. The photograph shows that the packing pellets, which were free-flowing before the high heat exposure, have bonded to one another as a result of the high temperature exposure.

FIG. 11 is a diagrammatic, cross sectional view of a package of batteries packed in an outer box and protected with a layer of packing pellets as shown in FIGS. 1 and 2.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The terms “about” or “approximately” as used herein denote deviations from the exact value by +/−10%, preferably by +/−5% and/or deviations in the form of changes that are insignificant to the function.

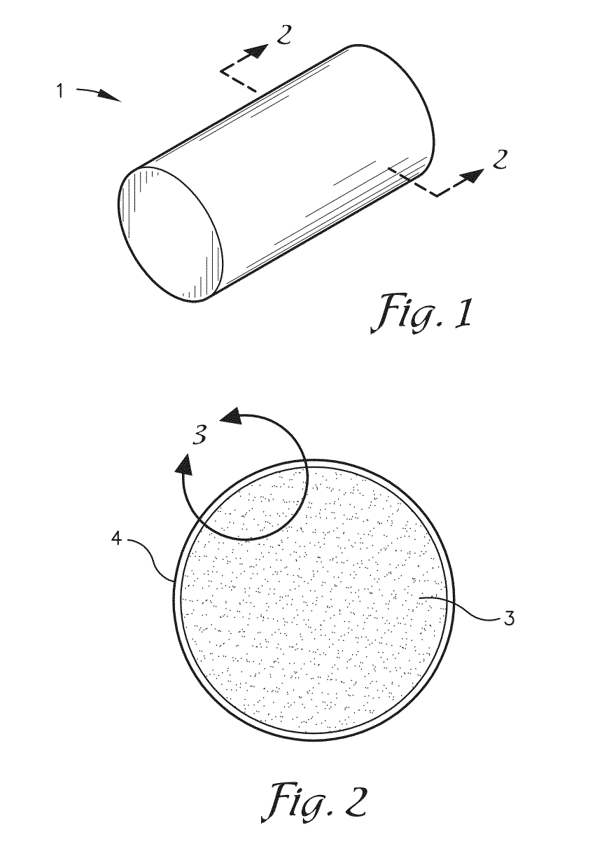

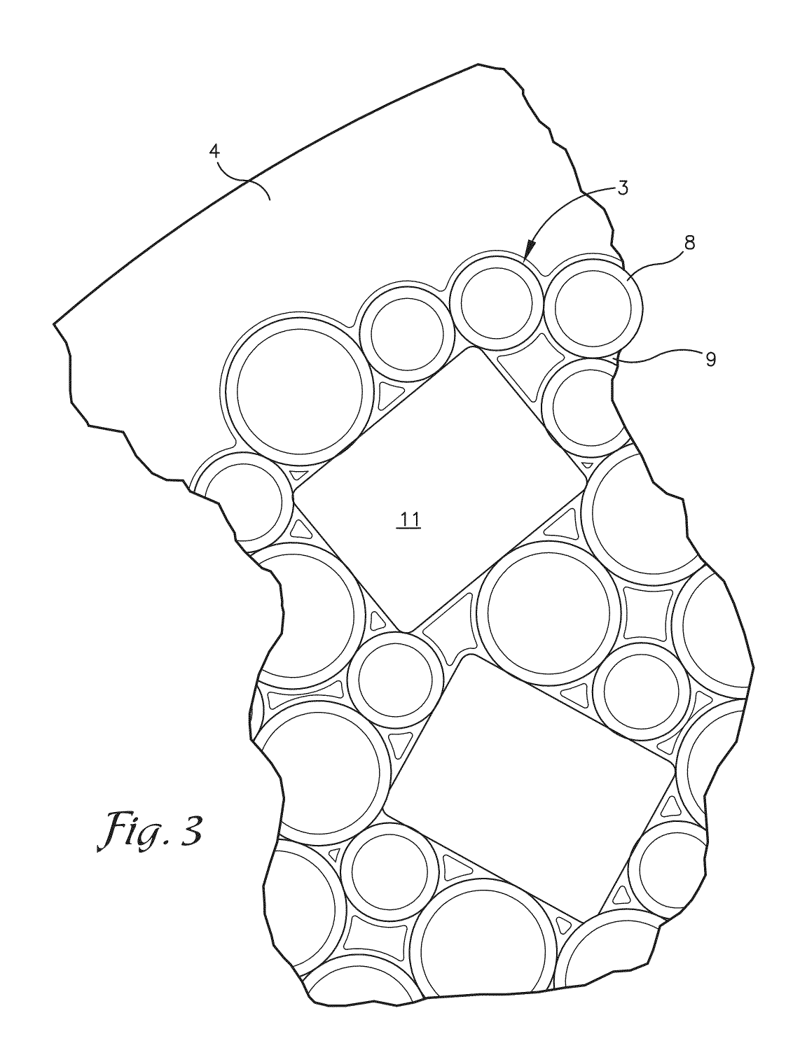

An embodiment of packing material in accordance with the present invention includes insulating, loose-fill, particulate material or media that freely flow at typical ambient room temperatures. One example of a form of individual particle or pellet 1 of loose fill packing media, is shown in perspective in FIG. 1 and in cross-section in FIG. 2. In the embodiment shown, the pellet or particle 1 of loose fill packing media is cylindrical. It is to be understood that the particles or pellets 1 could be formed in other shapes. Each particle or pellet 1 of loose fill packing media includes a foam core 3 formed from material adapted to retain its shape at elevated temperatures and a coating 4 that swells or foams and then chars at elevated temperatures. In a preferred embodiment, the coating 4 is an intumescent material. It is to be understood that, the thickness of the coating 4 as shown in FIG. 1 is exaggerated relative to the diameter of the foam core 3. As used herein, the term elevated temperature generally means temperatures above standard room temperatures or temperatures at which goods, such as lithium batteries or other flammable materials, might normally be stored or transported.

The foam produced by heating of the intumescent material above a certain elevated temperature fills voids between the pellets 1 to increase the insulating properties of the packing material and helps prevent flames from passing through the voids. The foam generated from adjacent pellets 1 merges or intermixes and then an outer layer of the intermixed foam chars which helps hold together the mass or agglomeration of pellets 1 including the foamed intumescent material.

FIG. 3 is a fragmentary, schematic representation of a greatly magnified cross-sectional view of a cross-section of a pellet 2 to provide a graphical representation of a cross-sectional view of the foam core 3 to facilitate a description of the components, but is not intended to be an exact representation of the relative size, shape, distribution and orientation of the individual components.

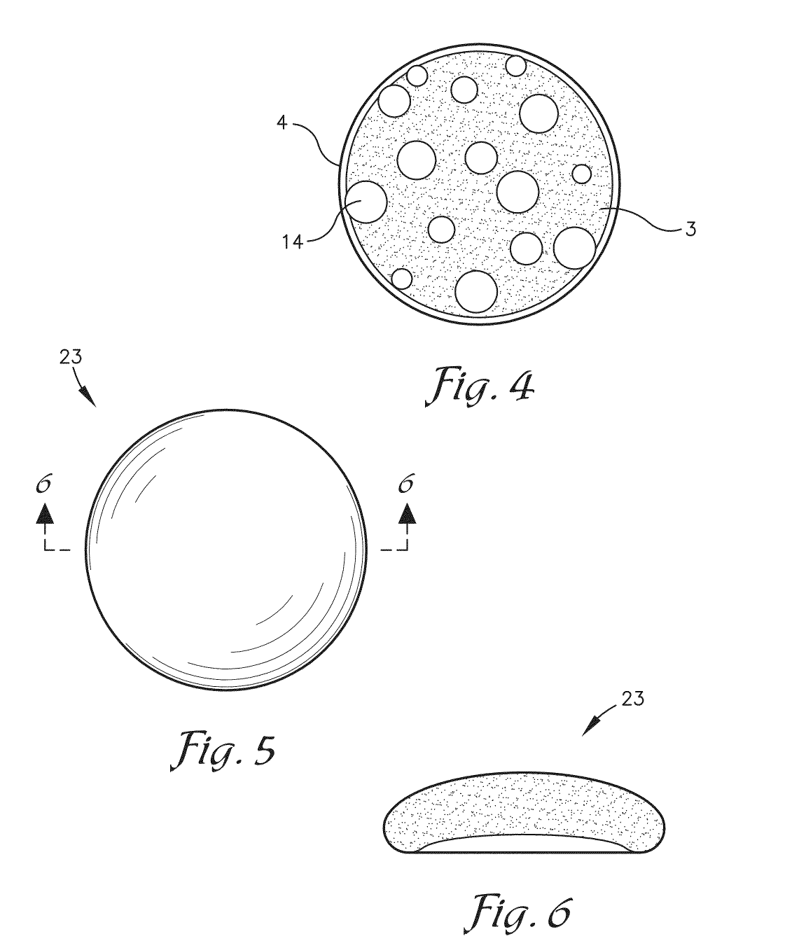

The foam from which foam core 3 is formed comprises a syntactic foam including micro-balloons 8 dispersed in a matrix 9 formed from a thermoset resin which when cured retains its shape at elevated temperatures. The foam core 3 may also include fine particles 11 of heat absorbing materials, such as phase change materials, dispersed in the matrix 9. The phase change materials change phase and therefore absorb heat at elevated temperatures. An alternative embodiment of the foam core 3, as shown in cross-section in FIG. 4, may also include expanded polystyrene particles or beads 14 dispersed in the matrix of thermoset resin with micro-balloons and optionally fine particles of a phase change material dispersed therein.

A thermoset resin particularly well adapted for forming the foam cores 3 is a cured resole phenolic resin such as phenol-formaldehyde resin. Alternative thermoset resins include epoxy, urethane, siloxane, vinyl ester, melamine-formaldehyde, urea-formaldehyde polymer resins or thermosetting polyester resins. A cured resole phenolic resin is typically produced by mixing a phenolic resin premix with an acid catalyst to initiate cross-linking of the phenolic resin in the phenolic resin premix. The phenolic resin premix is produced by a base-catalyzed condensation reaction of phenol and formaldehyde. Examples of commercially available phenolic resin premixes which may be utilized include Cellobond J2027L and Cellobond J201235L phenolic resin premixes. A preferred acid catalyst may include a phosphoric acid ester such as Budit 380 or an aryl sulfonic acid such as Phencat 15 acid, or mixtures of the two. The acid catalyzed phenolic resin is preferably cured at mildly elevated temperatures in the range of 110 to 150 degrees Fahrenheit (43 to 66° C.). The cured phenolic resins are stable to 300 degrees Fahrenheit (149° C.) or higher. At yet higher temperatures they may partially decompose but do not melt at elevated temperatures and therefore the matrix comprising the foam cores 3 retains its structure or shape at elevated temperatures. Because the foam cores 3 retain their shape at elevated temperatures, a layer of pellets 1 formed from foam cores 3 will still provide a barrier to heat transfer and block flames from reaching the flammable material encased in the pellets 1.

The micro-balloons or microspheres 8 are low density, expanded, thermoplastic microspheres which are mixed with the phenolic resin premix prior to addition of the acid catalyst. Microspheres may be obtained in an already expanded state, as in the embodiments described above, or prior to expansion as expandable microspheres as in an embodiment described hereafter. Expandable microspheres, which may also be referred to as micro-balloon or microsphere pre-cursers, comprise a thermoplastic shell encapsulating a volatile liquid. Upon heating to a temperature high enough to soften the thermoplastic shell, the volatilization of the volatile liquid causes the microsphere pre-curser to expand. An average diameter of an expandable microsphere may be six to forty micrometers with a density of 900 to 1400 kg/m³. An average diameter of an expanded microsphere can be 15 to 90 micrometers with a density of 15 to 70 kg/m³. Expancel 551 WE is a commercially available wet, expanded microsphere which may be used to form the foam cores 3. Other examples include Expancel 461 WE and Expancel 921WE. The thermoplastic forming the microspheres may be an acrylonitrile-vinylidene chloride copolymer.

Suitable heat absorbing materials 11, having particularly high potential for heat absorbance, include hydrates of inorganic oxides that release water, or change phase, in the temperature range of interest, with concomitant absorption of heat. Substances in this class include sodium tetraborate decahydrate (borax), aluminum sulfate decahydrate, sodium orthophosphate dodecahydrate, calcium sulfate dihydrate (gypsum), alumina trihydrate, magnesium hydroxide, and boric acid. Other examples may be found that absorb heat in the temperature range of interest. Formulations may include combinations of two or more heat absorbing material which change phase, and therefore absorb heat at different temperatures.

The properties of gypsum or calcium sulfate dihydrate allow it to absorb excess heat at temperatures in the range 200 to 300° F. (93 to 149° C.). Alumina trihydrate is effective at absorbing excess heat at higher temperatures around 400 to 600° F. (204 to 316° C.). Boric acid is effective at absorbing excess heat in two temperature ranges, 200 to 300° F. (93 to 149° C.) and 500 to 600° F. (260 to 316° C.). Using a combination of heat absorbing materials allows results in pellets that absorb heat and reduce heat transfer across a layer of pellets 1 for a broader range of temperatures.

Expanded polystyrene beads or particles 14 may be used as a low density filler to reduce the cost of the pellets by reducing the volume of the other components utilized including the thermoset resin and the microspheres which are more expensive on a volumetric basis than the polystyrene beads 14. Expanded polystyrene beads 1/16 to 3/16 of an inch in diameter may be utilized and added to the components used to form the foam core prior to addition of the catalyst for initiating polymerization of the thermoset resin.

Water may be added to the mixture of components to facilitate mixing of the ingredients and to adjust the consistency to facilitate extrusion. A surfactant may be included in the mixture of components forming the foam core prior to addition of the acid catalyst to aid in more uniform dispersion of the components. A silicone fluid may be incorporated into the mixture as a processing aid. A colorant may also be added to obtain a desired color. Additional additives may be included to facilitate formation and handling of the foam cores 3.

The components forming the foam core, excluding the catalyst, are initially mixed together to obtain a generally uniform mixture of components which may be referred to as a foam premix. In one embodiment, the foam premix is formed by mixing expanded microspheres, with the heat absorbing material such as boric acid or gypsum or both, a phenolic resin premix, a surfactant, silicone fluid, a colorant and water. The mixture is stirred until the components are substantially uniformly dispersed in the foam premix.

The acid catalyst is then added to the foam premix and mixed thoroughly to initiate cross-linking or curing of the resole phenolic resin. The catalyst may comprise one or more catalysts. If multiple catalysts are used, the catalysts are preferably mixed together prior to adding to the foam premix. The foam premix with catalyst added may be referred to as a catalyzed foam premix. The catalyzed foam premix is shaped into a plurality of foam cores 3 of a desired shape. In one embodiment, the cores may be extruded through a round dye and cut to a desired length to form cylindrical foam cores 3. It is anticipated that foam cores 3 having a diameter of between approximately ¼inch (6.4 mm) and 1 inch (25.4 mm) and a length of approximately ½ inch (12.7 mm) to 2 inches (51 mm) may be particularly useful and easy to handle for use as a loose fill packing media. An exemplary pellet may have a diameter of approximately ¾inch (19 mm) and a length of approximately 1½ to 2 inches (38 to 51 mm). Alternately, disk-shaped cores might be formed by extrusion of larger diameter cylinders, say 1-2 inches (25 to 51 mm), by cutting to shorter lengths, say ½ to 1.0 inch (13 to 25 mm).

It is foreseen that a wide variety of shapes and methods of forming the catalyzed foam premix into a selected shape may be utilized. In addition to cylinders and rods, the foam cores may be formed as cubes, spheres, disks, or other symmetrical, asymmetrical or irregular shapes. Sizes may range from a small fraction of an inch to several inches. The pellets or packing media may be formed by extrusion and cutting, compression molding or rolling followed by cutting. It is foreseen that dyes of a variety of shapes can be used to create different shaped extrusions, including polygonal or star shaped.

The shaped catalyzed foam premix is cured until cross-linking of the thermoset resin is relatively complete. For a phenolic resin, as described above, the shaped catalyzed foam premix may be cured by heating in circulating air to mildly elevated temperatures in the range of 110 to 150 degrees Fahrenheit (43 to 66° C.) until cured to a constant weight.

Referring to FIGS. 5 and 6, an alternative embodiment of a foam core 23 is shown which is formed using microsphere pre-cursers. The constituents of the foam premix are the same as describe above except microsphere pre-cursers are substituted for expanded microspheres. After the catalyst is added, the semi-liquid catalyzed foam premix is deposited in dollops on a tray and then heated to mildly elevated temperatures to expand the microspheres and cure the catalyzed foam premix. The resulting foam cores 23 may be described as cookie or puck shaped.

Other means for creating foam cores are foreseen and may include incorporation of a low boiling point substance, such as pentane or hexane, in a mixture of heat absorbing material, thermosetting resin, catalyst and surfactant. The mixture is then heated to concurrently volatilize the low boiling point substance causing expansion and the formation of bubbles or voids in the resin and curing the resin resulting in foam pieces or cured foam cores.

The cured foam cores 3 and 23 are coated with a coating 4 which preferably comprises an intumescent material. A preferred intumescent material is an acid cured melamine resin. The melamine resin may be formed using melamine and a catalyst such as phosphoric acid ester. The intumescent material may also comprise or include an acidic phosphorus compound, ammonium polyphosphate or an epoxy resin. The foam cores 3 and 21 may be coated by tumbling the foam cores in a container of an intumescent coating until suitably coated. It is understood that the foam cores may be coated by other means including by spraying or dipping. The coated cores are cured at mildly elevated temperatures. The resulting pellets 1 are form lightweight pellets which are free flowing (i.e. they do not stick together) at room temperatures and temperatures below approximately 200 degrees Fahrenheit (93° C.).

When the surface temperature of individual packing pellets 1, each comprising a syntactic micro-balloon and cured phenolic resin foam core 3 and coating 4 of intumescent material, is raised to a first elevated temperature of approximately 200° F. to 250° F. (93 to 121° C.), the coating 4 of intumescent material is believed to become semi-fluid, sticky and tacky, causing adjacent pellets 1 to adhere to one another. As the surface temperature is raised to a second elevated temperature of approximately 350° F. to 400° F. (177 to 204° C.) the coating of intumescent material foams and swells to fill space or gaps between adjacent pellets or particles 1. As the surface temperature increase to about 400° F. to 450° F. (204 to 232° C.) and higher, the surface of the particles 1, including the foamed intumescent material, chars. The carbonaceous char exhibits very high thermal stability. The heat absorbing material contained in the foam core 3 absorbs heat and therefore reduces heat transfer through the pellets 1. A layer of packing pellets or particles 1 may therefore be used to form an insulative, heat-absorbing, flame-resistant barrier protecting and enveloping a packed item surrounded by the particles 1. The particles typically resist combustion at temperatures well above the ignition or combustion point of other packing materials.

### Example 1

Foam cores for packing media or pellets were prepared starting with 1000 grams of Expancel 551WE wet, expanded microspheres and adding 667 grams of gypsum powder and 53 grams of boric acid powder to a paddle mixer. A mixture of 147 grams of Cellobond J2027L phenolic resin, 147 grams of Cellobond J201235L phenolic resin, 13 grams of DC193 surfactant, 8.0 grams of DC510 silicone fluid, 4.8 grams of yellow colorant and 500 grams of water were then added to the paddle mixer and stirred for five minutes. Thereupon a catalyst premix comprising a mixture of 50 grams of Phencat 15, 50 grams of Budit 380 and 1 gram of red colorant was added, and the resulting mixture was stirred for an additional five minutes, resulting in a compound with uniform color and consistency. The catalyst premix was prepared by mixing or stirring the components for several minutes, at moderate speed, in a suitable mixing vessel, using a Cowles mixer blade.

The resulting mixture was extruded through a 0.75 inch (19-mm) diameter circular die. The resulting cylinders, cut to lengths of 1.5 to 2.0 inches (38 to 51 mm), were dried to constant weight in circulating air at mildly elevated temperatures at 110 to 150° F. (43 to 66° C.).

Set forth below is a table with a preferred range of concentrations of components for forming the foam cores.

TABLE 1
Example ranges of components for loose fill packing material

| | | Weight | |
|---|---|---|---|
| | | (weights are relative | |
| | | to microballoons at | |
| | | 100 weight units) | |
| Premixes/final mix | Component | Low | High |
| Resin premix | Resol phenolic resin | 11 | 56 |
| | Silicone surfactant | 0.7 | 1.3 |
| | Silicone fluid | 0.7 | 1.3 |
| | Yellow colorant | 0.0 | 0.9 |
| Catalyst premix | Phosphoric acid ester | 2 | 11 |
| | Sulfonic acid | 2 | 11 |
| | Red colorant | 0.0 | 0.4 |
| Remaining ingredients | Thermoplastic microballoons | 100 | 100 |
| | (*) | | |
| | Calcium sulfate dihydrate, | 44 | 78 |
| | powder | | |
| | Boric acid | 4.0 | 22 |
| | Water | 0.0 | 14 |

(*) Acrylonitrile-vinylidene chloride copolymer, wet, expanded

The cured, rod shaped packing material pieces were then coated with an acid-cured melamine resin to form an intumescent coating and allowed to cure and dry in a warm circulating air environment for an effective period of time. Coating was performed by placing 500 grams of foam cores 3 produced in accordance with Example 1 in a suitably sized plastic bag. A catalyzed melamine resin comprising 315 grams of AF2000 from Akro Fire, Inc., were then added to the bag and the contents tumbled and shaken until the foam cores 3 were thoroughly wetted. The wetted cores were then spread onto a suitable non-absorbing surface, and allowed to dry in a circulating air at mildly elevated temperature, resulting in pellets 1 including foam core 3 and intumescent coating 4.

### Test 1: Burn Through

A 14.2×14.2×7.6″ (362×362×194-mm) Hazmat cardboard carton 110 filled with packing pellets, made in accordance with Example 1, surrounding a simulated lithium battery pack 115 was subjected to a direct flame impingement test in a manner similar to 14CFR 25.855, Appendix F, Part III. The exterior of the carton 110 was subjected to a flame at a temperature of greater than 1600° F. (871° C.) for 5 minutes. At the end of the five minutes the remains were inspected. The parts of the cardboard box directly contacted by the flame had burned away, exposing underlying structures. It was found that the individual particles of the packing media had bonded or adhered to one another, swollen and charred, thus encapsulating and protecting the simulated battery pack. A temperature probe located directly above the battery pack 115 indicated that the temperature proximate the battery pack did not exceed 92° F. (33° C.).

### Test 2: Thermal Resistance

A 14.2×14.2×7.6″ (362×362×194-mm) Hazmat cardboard carton 110 filled with packing pellets 1, made in accordance with Example 1, surrounding a simulated lithium battery pack 115 was subjected to a thermal resistance test to assess performance and efficacy of the packing pellets in an environment such as a suppressed cargo fire, in a manner in accordance with HM224B of PHMSA (Pipeline and Hazardous Materials Safety Administration). This test simulates exposure of the carton 110 to a fire in cargo or storage area that is suppressed by Halon. The carton 110 was placed in a 400° F. (204° C.) circulating air environment for three hours. A temperature probe located directly above the battery pack 115 indicated a maximum temperature proximate the battery pack of 202° F. (94° C.). This temperature is well below that which might cause the batteries to go into thermal runaway.

### Test 3: Thermal Runaway

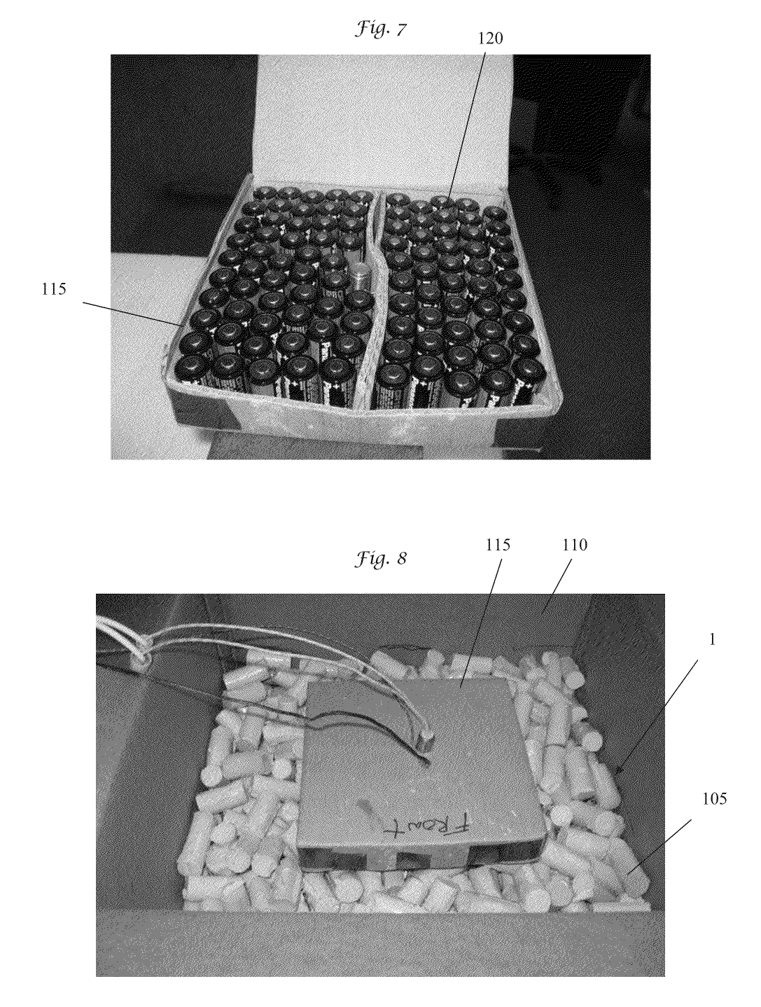

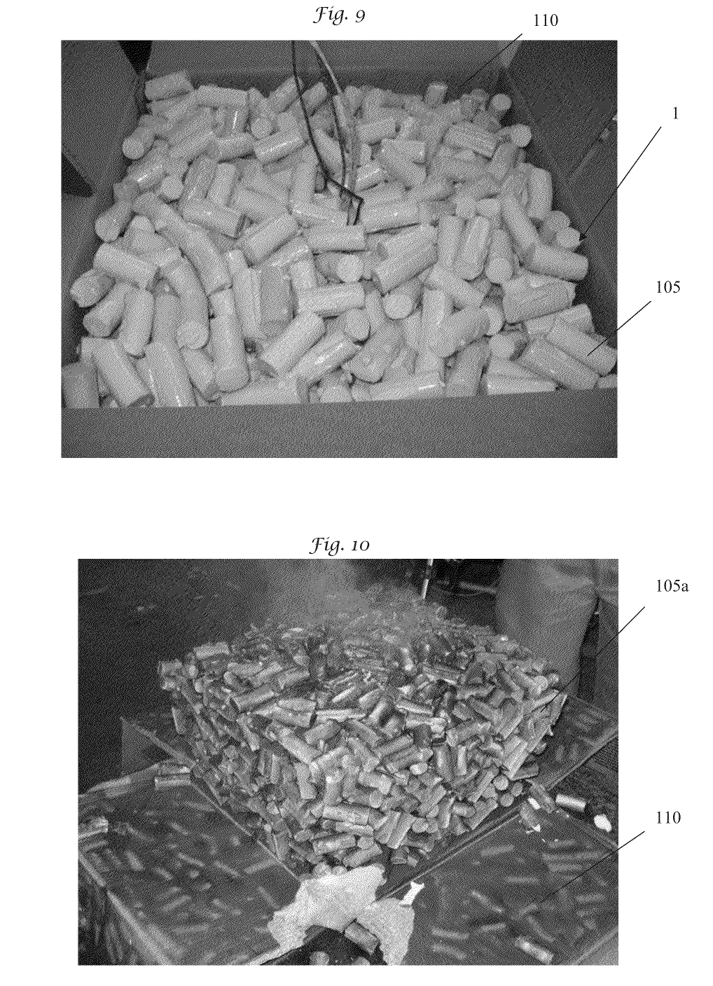

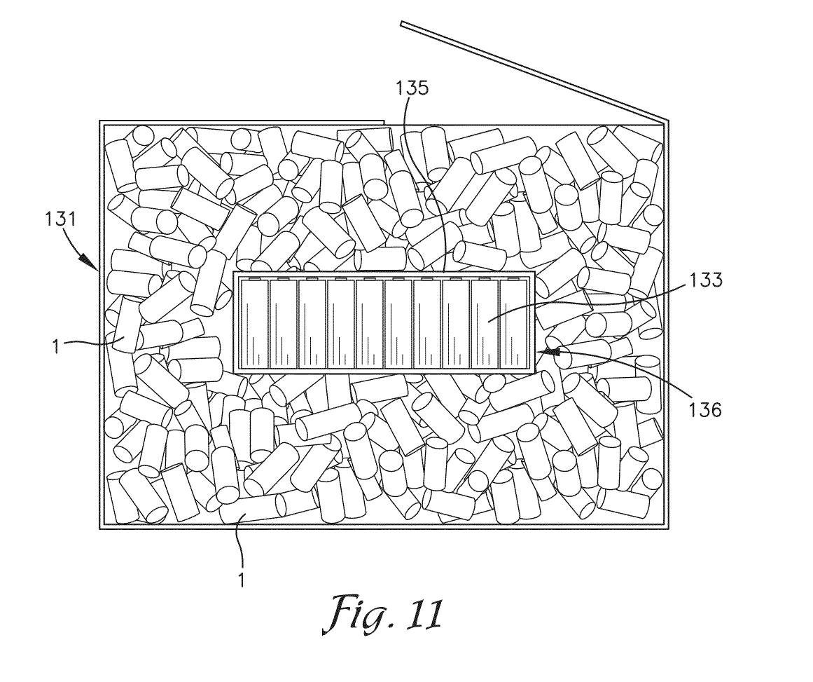

One hundred CR123A cells 120 were placed in close proximity to one another in a 10×10 array, in a 7.2×7.2×1.5″ (183×183×38-mm) light weight cardboard box 122 (see FIG. 7). A 75-watt cartridge heater was fitted into the center of the array, and thermocouples were attached to the heater, an adjacent cell and the four corner cells. The box was closed and taped shut, and then placed in the center of a 14.2×14.2×7.6″ (362×362×194-mm) Hazmat box 110 that had been filled and shaken down with protective packing pellets 2 (i.e. packing material prepared in accordance with Example 1) to a depth of three inches (76 mm) (see FIG. 8). Additional cylinders 105 were filled around and above the box 122 containing the batteries 120, heater and thermocouples, until the outer box 110 was level full after shaking down (see FIG. 9). The depth or thickness of packing pellets 1 on all sides of the box 122 was approximately three inches or greater. The heater and thermocouple leads were brought outside the box, and the box 110 was closed and taped. The heater thermocouple was connected to a controller, which, in turn, provided power to the heater. The temperatures of remaining thermocouples were recorded by a data acquisition system. In a safe, well-ventilated area, the temperature of the heater was raised quickly to 400° F. (204° C.). No visible effect was seen for 16 minutes. The control temperature was then raised to 500° F. (260° C.). After five minutes, muffled popping and hissing sounds were heard, soon accompanied by smoke emanating from seams in the box 110. The temperatures of the thermocouples increased rapidly, to greater than 1500° F. (815° C.). Smoke emissions decreased to low levels within 10 minutes after first appearing. The outer box 110 remained intact, with no more than limited signs of discoloration at the seams. FIG. 10 is a photograph of the contents of the box 110, including packing pellets 1, following a thermal runaway test after the outer box 110 has been cut and removed. The photograph shows that the packing pellets 1, which were free-flowing before the high heat exposure, have bonded to one another as a result of exposure to temperatures high enough to cause the intumescent coating 4 to become tacky and foam. These results show that the runaway of a close-packed assembly of 100 CR123A batteries 120, prompted to go into thermal runaway condition at no more than 500° F. (260° C.), and thereupon reaching temperatures in excess of 1500° F. (815° C.), can be contained in the subject outer box 110 without emitting flames.

### Example 2

An alternative formulation of the foam cores was prepared by mixing 1000 grams of Expancel 551 WE wet, expanded microspheres with 667 grams of alumina trihydrate and 53 grams of boric acid in a paddle mixer. A mixture of 147 grams of Cellobond J2027L phenolic resin, 147 grams of Cellobond J201235L phenolic resin, 13 grams of DC193 surfactant, 8.0 grams of DC510 silicone fluid, 4.8 grams of yellow colorant and 500 grams of water was then added to the microspheres and heat absorbing material in the mixer and the components were stirred for five minutes. Thereupon a mixture of 50 grams of Phencat 15, 50 grams of Budit 380 and 1 gram of red colorant was added, and the resulting mixture was stirred for an additional five minutes, resulting in a compound with uniform color and consistency. The resulting mixture was extruded through a 0.75″ (19-mm) die. The resulting cylinders, cut to lengths of 1.5 to 2.0 inches (38 to 51 mm), were dried to constant weight in circulating air at mildly elevated temperatures.

### Example 3

To a mixture of 1000 grams of Expancel 551WE wet, expanded microspheres, 667 grams of Terra Alba gypsum and 53 grams of boric acid in a paddle mixer was added a mixture of 147 grams of Cellobond J2027L phenolic resin, 147 grams of Cellobond J201235L phenolic resin, 13 grams of DC193 surfactant, 8.0 grams of DC510 silicone fluid, 4.8 grams of yellow colorant and 500 grams of water. The mixture was stirred for five minutes. A 167-gram portion of expanded polystyrene beads, 1/16 to 3/16″ (1.6 to 4.8 mm) in diameter was added and stirred for an effective time to disperse the beads in the mixture. Thereupon a mixture of 50 grams of Phencat 15, 50 grams of Budit 380 and 1 gram of red colorant was added, and the resulting mixture was stirred for an additional five minutes, resulting in a compound with uniform color and consistency. The resulting mixture was extruded through a 0.75″ (19-mm) die. The resulting cylinders, cut to lengths of 1.5 to 2.0 inches (38 to 51 mm), were dried to constant weight in circulating air at mildly elevated temperatures.

### Example 4

To a stirred mixture of 103 grams of Cellobond J2027L phenolic resin, 103 grams of Cellobond J201235L phenolic resin, 7.3 grams of DC193 surfactant, 5.8 grams of DC510 silicone fluid, 2.9 grams of yellow colorant and 152 grams of water was added, in succession, with stirring, 104 grams of Expancel 551DU expandable microspheres, 460 grams of Terra Alba gypsum and 30 grams of boric acid. To the resulting stirred mixture was added a mixture of 15.7 grams of Phencat 15, 15.7 grams of Budit 380 and 0.5 grams of red colorant. The resulting mixture was promptly deposited in small portions or dollops on a horizontal, lightweight sheet that had been covered with release film. After many of these portions, spreading initially to 0.5 to 1.0-inch (13 to 25-mm) diameter, had been deposited on the flat sheet, the sheet was placed in a circulating air oven that had been preheated to 260° F. (127° C.). The sheet was left in the oven until all of the deposited dollops had expanded to their maximum extent, and had cured sufficiently that they were no longer soft, unusually about seven minutes. Shapes were similar to cookies. The resulting tray of “cookies” was then placed in a warm dry area with circulating air and allowed to dry to constant weight at 110 to 150° F. (43 to 66° C.).

The foam cores formed in Examples 2-4 were coated with a coating 4 of intumescent material in a manner similar to that set forth in Example 1.

Bulk densities of loose fill made without the addition of expanded polystyrene beads, and then coated with intumescent coating, were typically in the range 7.2 to 10.8 pounds per cubic foot (pcf) (115 to 173 kg/m³). Bulk densities of loose fill that included expanded polystyrene beads, and were then coated with intumescent coating, were typically in the range 3.6 to 6.3 pounds per cubic foot (58 to 108 kg/m³). The amount of intumescent coating in either case was in the range 1.5 to 2.9 pounds per cubic foot (24 to 46 kg/m³).

The packing pellets 1 as described above and formed by any of the Examples discussed above may be used with a conventional box such as a cardboard box 131. Packages of flammable, heat-sensitive or heat-releasing material or devices, such as a plurality of lithium batteries or devices containing lithium batteries 133 are secured together in an inner box 135 or otherwise bundled together as a package 136. An outer box 131 is selected which is volumetrically larger than the package 136 of flammable material. The outer box 131 is preferably sized so that the spacing between the sidewalls of outer box 131 and a package 136 positioned in the center of the box is at least than three inches (76 mm) in any direction.

A first quantity of pellets or loose fill packing media 1 is poured across the bottom of the outer box 131 and preferably shaken to cause the first layer of pellets 1 to settle to form a first layer of pellets 1 having a preferred depth of at least three inches (76 mm). The package 136 of flammable material is then placed on top of the first layer of pellets 1 and centered relative to the sidewalls of the outer box 131. A second quantity of pellets 1 is poured into the outer box 131 to fill the space between the sides of inner box 135 and outer box 131 and to cover the inner box 135 or package 136 to a depth of at least three inches (76 mm) and preferably to the top of the outer box 131. As noted previously the outer box 131 is sized relative to the outer box 131 so that the layer of pellets 1 between the sidewalls of inner box 135 or package 136 and outer box 131 is at least three inches (76 mm). The top of the box is then closed and taped shut for shipping.

Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A loose fill packing media comprising:
a foam core formed from a thermoset resin; and
a coating of a material applied over said foam core which foams at an elevated temperature.

2. The loose fill packing media as in claim 1 wherein said elevated temperature at which said coating foams is approximately three hundred and fifty degrees Fahrenheit or greater.

3. The loose fill packing media as in claim 1 wherein said elevated temperature at which said coating foams is in a range of approximately three hundred and fifty degrees to five hundred degrees Fahrenheit.

4. The loose fill packing media as in claim 1 wherein said elevated temperature at which said coating foams is a second elevated temperature and said coating enables cohesion among loose fill media at a first elevated temperature.

5. The loose fill packing media as in claim 4 wherein said first elevated temperature at which said coating enables cohesion among loose fill media is approximately two hundred degrees Fahrenheit or greater.

6. The loose fill packing media as in claim 1 wherein said coating chars at or above said elevated temperature.

7. The loose fill packing media as in claim 1 wherein said foam core further comprises micro-balloons dispersed in a matrix of said thermoset resin.

8. The loose fill packing media as in claim 1 wherein said foam core further comprises particles of a phase change material dispersed therein.

9. The loose fill packing media as in claim 1 wherein said foam core further comprises fine particles of a hydrous inorganic material dispersed therein.

10. The loose fill packing media as in claim 7 wherein said foam core further comprises expanded polystyrene particles dispersed therein.

11. A loose fill packing media comprising;
a foam core formed from a thermoset resin; and
a coating of an intumescent material applied over said foam core.

12. The loose fill packing media as in claim 11 wherein said foam core comprises micro-balloons dispersed in a matrix of said thermoset resin.

13. The loose fill packing media as in claim 11 wherein said thermoset resin is a phenolic resin.

14. The loose fill packing media as in claim 13 wherein an acid catalyst is used to accelerate curing of said thermoset resin.

15. The loose fill packing media as in claim 13 wherein said thermoset resin is a resole phenolic resin.

16. The loose fill packing media as in claim 13 wherein said phenolic resin comprises phenol-formaldehyde resin.

17. The loose fill packing media as in claim 11 wherein said foam core further comprises particles of a phase change material dispersed therein.

18. The loose fill packing media as in claim 11 wherein said foam core further comprises fine particles of a hydrous inorganic material dispersed therein.

19. The loose fill packing media as in claim 11 wherein said intumescent material includes a melamine resin.

20. The loose fill packing media as in claim 11 wherein said intumescent material includes an acidic phosphorous compound.

21. The loose fill packing media as in claim 11 wherein the intumescent material includes ammonium polyphosphate.

22. The loose fill packing media as in claim 11 wherein the intumescent material includes an epoxy resin.

23. The loose fill packing media as in claim 12 wherein said foam core further comprises expanded polystyrene particles dispersed therein.

24. A process for producing loose fill packing material comprising:
mixing micro-balloons with a thermoset resin to form a foam premix;
adding a catalyst to said foam premix to induce curing of the thermoset resin around the micro-balloons and forming a catalyzed foam premix;
shaping the catalyzed foam premix into a plurality of uncured foam cores;
curing the uncured foam cores to form cured foam cores;
coating the cured foam cores with an intumescent material.

25. The process as in claim 24 wherein the intumescent material includes a melamine resin.

26. The process as in claim 24 wherein the intumescent material includes an acidic phosphorus compound.

27. The process as in claim 24 wherein the intumescent material includes ammonium polyphosphate.

28. The process as in claim 24 wherein the intumescent material includes an epoxy resin.

29. The process as in claim 24 wherein said thermoset resin is a phenolic resin.

30. The process as in claim 29 wherein said thermoset resin is resole phenolic resin.

31. The process as in claim 24 wherein the step of forming a foam premix includes mixing particles of a phase change material with the thermoset resin and micro-balloons.

32. The process as in claim 24 wherein the phase change material is a hydrous inorganic material with the micro-balloons and the thermoset resin.

33. The process as in claim 24 where in the step of forming a foam premix includes mixing expanded polystyrene particles with the thermoset resin and micro-balloons.

34. A process for producing loose fill packing material comprising:
mixing micro-balloon precursors with a thermoset resin and a catalyst to form a catalyzed precursor resin mixture;
dividing the catalyzed precursor resin mixture into selected portions;
heating the selected portions of catalyzed precursor resin mixture to a temperature at which a volatile compound within the precursor volatilizes, expanding the micro-balloon precursors to form micro-balloons and at which the thermoset resin begins to cure to form uncured foam cores;
allowing the uncured foam cores to cure; and
coating the cured foam cores with an intumescent material.

35. A process for producing loose fill packing material comprising:
mixing a low boiling point substance with a thermoset resin and a catalyst to form a catalyzed resin mixture;
dividing the catalyzed resin mixture into selected portions;
heating the selected portions of catalyzed resin mixture to a temperature at which the low boiling point substance volatilizes, expanding the catalyzed resin mixture and forming bubbles therein, and at which the thermoset resin begins to cure to form uncured foam cores;
allowing the uncured foam cores to cure; and
coating the cured foam cores with an intumescent material.

36. A method of packing a package of flammable, heat-sensitive or heat-releasing materials or devices comprising the steps of:
selecting a box which is volumetrically larger than the package;
placing a first layer of a loose fill packing media across the bottom of the box; the loose fill packing media comprising a plurality of packing pellets comprising a foam core formed from a thermoset resin and a coating of an intumescent material applied over the foam core;
placing the package on top of the first layer of the loose fill packing media;
filling the box with an additional quantity of the loose fill packing media so that the package is surrounded by loose fill packing media.

37. The method of claim 36 wherein the package of flammable material comprises a package of lithium batteries.

38. The method of claim 36 wherein the package comprises a package of devices containing lithium batteries.

39. The method of claim 36 wherein the loose fill packing media surrounds the package to a depth of at least three inches in all directions.

40. The method as in claim 36 wherein the intumescent material includes an acid catalyzed melamine resin.

41. The method as in claim 36 wherein the intumescent material includes ammonium polyphosphate.

42. The method as in claim 36 wherein the intumescent material includes an epoxy resin

43. The method of claim 36 wherein said thermoset resin is a phenolic resin.

44. The process as in claim 43 wherein said thermoset resin is resole phenolic resin.
